(19) United States
(12) Patent Application Publication
(10) Pub. No.: US 2024/0193303 A1
(43) Pub. Date: Jun. 13, 2024

(54) DATA ACQUISITION IN A VEHICLE

(71) Applicant: AVL LIST GMBH, Graz (AT)

(72) Inventor: Peter Priller, Gratwein-Straßengel (AT)

(21) Appl. No.: 18/286,837

(22) PCT Filed: Apr. 14, 2022
(86) PCT No.: PCT/AT2022/060116

§ 371 Date: Oct. 13, 2023

(30) Foreign Application Priority Data
Apr. 15, 2021 (AT) A50282/2021

(51) Int. Cl. G06F 21/62; G07C 5/08; H04W 12/02

(52) U.S. Cl. CPC G06F 21/6254; G07C 5/085; H04W 12/02

(57) ABSTRACT

Disclosed is a method for data acquisition in a vehicle, comprising at least one data acquisition unit and at least one processing unit, wherein the at least one data acquisition unit records at least one vehicle data record that is marked by at least one protected vehicle data record. The vehicle data is modified on the basis of a degree of anonymity by a preprocessing operation in the processing unit and is stored as secure vehicle data such that it is impossible to draw conclusions about the protected vehicle data.

Method for data acquisition in a vehicle, comprising at least one data acquisition unit and at least one processing unit, wherein the at least one data acquisition unit records at least one vehicle data record that is marked by at least one protected data record.

In recent years, the need for data acquisition in vehicles has become ever greater. This is promoted especially by the desire for autonomous or automated driving—“AD” for short. Autonomous driving is understood to mean a quasi “Autopilot System” which, for example, can carry out steering, indication, acceleration, and braking maneuvers along and transversely to the traffic lane without human intervention. While such autopilot systems are already widely implemented industrially in limited areas (factory premises), use by the general public is still a way off, among other things because complex ethical questions stand in the way of introduction. There is a desire for better data acquisition in order to be able to develop better and safer systems.

However, data acquisition in vehicles is very important not just for the development and improvement of driver assistance systems (ADAS) or autonomous driving. For example, in vehicle development, optimization, verification, validation, and certification, there is a need to test a wide variety of components and systems of the vehicle under real driving conditions. For this purpose, the vehicle is moved in real road traffic, and at the same time required data is acquired. Specifically, the emissions in real operation—“real driving emission” (RDE)—are to be determined, due to stricter legal requirements.

During data acquisition in vehicles, data for various vehicle parameters, e.g., engine power, speed, torque, acceleration, position, battery voltage in (part-)electrical drive trains, emission values, etc., are recorded in the test vehicle for later evaluation. The data are either collected and stored in the vehicle and evaluated after the test trip (offline test trip), or directly transmitted to a test center and evaluated there (online test trip).

In the case of data acquisition in vehicles, personal data is particularly problematic, e.g., due to EU's General Data Protection Regulation (GDPR), which stipulates that personal data may only be processed in a manner that ensures appropriate security of the personal data, including protection against unauthorized or unlawful processing. By definition, personal data is information on an identified or identifiable person. The primary objective of the data acquisition in the vehicle is to acquire only data of the vehicle, and not personal data. However, in certain cases, it is inevitable that data can be unintentionally assigned to persons, for example, the current position of the vehicle is at the same time also the position of the driver and passengers. Vehicle data can also be used to determine actions or characteristics of the driver (e.g., acceleration and braking behavior can be used to infer attention, emotions, influence of certain substances on the driver, etc.).

Vehicles with driver assistance systems are sometimes equipped with sensors, whose task is to recognize and categorize other road users—for example, pedestrians in the environment of the vehicle and their intentions. This results “indirectly” in personal data (data regarding the driver, passengers, pedestrians in the environment of the vehicle). For example, information results from the behavior of drivers and other road users, but also position data, and therefore requires special protection.

Accordingly, the “indirect access to/conclusion about” protected data, especially personal data, is more problematic. This is understood to mean that conclusions can be drawn about persons, their characteristics, and their immediate activity on the basis of other acquired data in the vehicle, e.g., the position localization, camera recordings, engine data (such as power, speed, torque), dynamic data (such as acceleration, speed), etc. (keyword: “big data analytics”). This may not only involve data on the driver or passengers, but also data on passers-by and third parties who have interacted with the vehicle while driving, such as stopping in front of a crosswalk or a traffic light, other road users, etc.

For example, it is not possible to draw direct conclusions about protected data, in particular personal data, from a temporal acceleration profile acquired during a trip with the vehicle. However, such a conclusion is quite possible indirectly. A temporal speed profile and a temporal road course can be determined from the acceleration profile by temporal integration. Assumptions about starting points of the trip (starting conditions) can be made on the basis of other acquired data, such as a vehicle designation, a starting time, etc. Possible paths can be determined by superimposing digital road maps, traffic data at this time, and the calculated speed profile (e.g., braking before a narrow curve, waiting when turning with oncoming traffic or at traffic lights, waiting for a short while in the event of a stop sign, etc.) and they can be ranked according to probability. If one of the possible paths reaches a sufficiently high match (Confidence Level), the sequence of specific locations of the vehicle can be specified from this at each (measurement) time, whereby the protected data (position of a person, stopping duration) would be compromised.

Systems such as ADAS do indeed acquire this data in and around the vehicle and use said data for direct control of the vehicle. However, the acquired data is not usually stored or transmitted. Additional measuring systems for observing vehicle behavior can be used, for example, during development for optimization or error analysis of ADAS or AD. For this purpose, however, these data should not be deleted immediately after use for the driving function, but, rather, be stored/transmitted to be able to analyze the function afterwards.

An encryption of the protected data would be one way to protect said data from unauthorized access, at least during the transmission and processing. However, the data to be protected is preserved in this case, whereby subsequent conclusions (after decryption of the data) about the protected data, and in particular personal data, are nevertheless possible.

DE 10 2006 043 363 A1 discloses a data acquisition process, wherein the acquired data are divided into two groups. Of these, one group has personal data, and the other does not. The personal group is checked by an intermediate body and removed. The second group is non-critical by assumption and can be processed. However, this approach requires that the acquired data can actually be divided into these two groups. However, this is generally not possible in practice.

Data acquired during a trip with a vehicle are usually marked by protected data, such as personally assignable characteristics of the driver, location of the trip, etc. For example, the driver type (e.g., conservative, sporty, aggressive) influences an acceleration profile of the vehicle and thus a time profile of the engine power, and, similarly, the topology of the road (road inclination, curves, etc.) or the loading of the vehicle (mass) influences a temporal profile of the engine power. An engine power acquired during the trip cannot thus simply be regarded as uncritical information, because it is marked by protected data, and conclusions about personal data can be drawn from it up to a certain extent.

The prior art thus discloses methods for data processing of data acquired by a vehicle during a trip, which prevent direct access to protected data; but indirect access to such protected data still remains possible.

It is therefore an object of the present invention to prevent indirect access to protected data on the basis of vehicle data acquired by a vehicle during a trip.

The present object is achieved in that a preprocessing operation of the at least one vehicle data record is carried out in the at least one processing unit, wherein the preprocessing operation comprises the following steps, taking into account a predetermined degree of anonymity, namely: loading the at least one vehicle data record into the preprocessing operation, applying at least one method to the at least one vehicle data record to modify the at least one vehicle data record, analyzing whether the degree of anonymity is met by the modified vehicle data record, and storing the at least one modified vehicle data record that meets the degree of anonymity as at least one secured vehicle data record to prevent indirect conclusion on the at least one protected data record.

In an advantageous embodiment, vehicle data are collected during a test trip with a vehicle. These vehicle data can be of different quality, e.g., power data of an engine, visual data from a video camera, exhaust gas data from an emission analysis unit, position data of a GPS sensor, data registered personally by the driver, etc.

Vehicle data which are relevant for a certain measurement campaign are preferably selected in a test trip. These could, for example, be RDE data of a diesel engine, which are, for example, dependent upon engine temperature, engine power, outside temperature, etc. Preferred vehicle data would then be nitrogen oxide content, aerosol particles, engine power, and engine temperature. The data acquisition units are then attached, for example, at different locations—for example on the engine and along the exhaust system. Cameras on the vehicle roof, or GPS position determination, can also be data acquisition units. These vehicle data are recorded during the test trip. Such vehicle data can, for example, depend upon a control variable, such as time, geographical position, engine speed, speed, and the like. All the control variables which the person skilled in the art requires for the evaluation can be used to index vehicle data records.

Preferably, test trips are carried out for data recording with test vehicles, and most preferably with preinstalled data acquisition modules. Test cars are preferably located in a parking lot of a company which carries out the tests and are driven by trained personnel. For example, this usually results in test trips with the same start and end points thus result and with a limited number of drivers. However, standard vehicles from current production can also be instrumented e.g., for vehicle fleets (delivery vehicles, taxis, rental cars, etc.), or individual vehicles for random sample analyses.

Further protected data can be added to protected data, such as driver and movement profile, during test trips. For example, test vehicles interact with other road users, such as other vehicles or passers-by. Various interactions with the test vehicle mark the acquired vehicle data of the data acquisition. For example, it is therefore possible to draw conclusions about license plates of other road users or the identity of passers-by by means of vehicle data from a video camera or from GPS position determination.

According to the invention, a processing unit is integrated into the vehicle, wherein the processing unit comprises a preprocessing operation, which converts vehicle data recorded during the test trip into secured vehicle data by means of at least one data acquisition unit, so that no indirect conclusion can be drawn on the protected data.

The preprocessing operation takes place via a specification of the probability of being able to identify protected data (“degree of anonymity”). Definitions of the degree of anonymity are given in relevant publications, such as Diaz, C., Seys, S., Claessens, J., & Preneel, B. (2002, April), “Towards measuring anonymity,” in International Workshop on Privacy Enhancing Technologies (pp. 54-68), Springer, Berlin, Heidelberg, or Edman, M., Sivrikaya, F., & Yener, B. (2007, May), “A combinatorial approach to measuring anonymity,” in 2007 IEEE Intelligence and Security Informatics (pp. 356-363), IEEE. If a vehicle data record meets a predefined degree of anonymity, it is stored as a secured vehicle data record and can be supplied to a further processing operation, if necessary. Preferably, after storage as a secured vehicle record, the protected data can no longer be accessed.

The degree of anonymity can also be coupled to a cost factor and contain a categorization. A cost factor describes the effort required to access protected data. Such a categorization is specified by the user and describes the risk that protected data can be accessed. Depending on the categorization, the value of the degree of anonymity can be adapted, and thus the degree of the modification of the vehicle data can be adapted in the preprocessing operation. If the risk is low, a vehicle data record can be modified only slightly and stored as a secured vehicle data record, and thus can be very close to the original vehicle data record.

In a highly preferred embodiment, the preprocessing operation models the influence of the protected data. This can be done by a correlation function which describes a marking of the unmarked vehicle data record by protected data, and merges into a vehicle data record. The marking of different vehicle data records can be mapped via different correlation functions. If a vehicle data record does not have any marking by protected data, it can, for example, be stored directly as a secured vehicle data record. A vehicle data record can also be marked by several protected data items, which can be mapped by one correlation function or also by several correlation functions.

It can also happen that a vehicle data record does not meet the degree of anonymity after a preprocessing operation and is discarded.

A context can also be used to be able to modify a model of the preprocessing operation depending upon the vehicle environment. Preferably, the context is generated via a data acquisition unit, which forwards influences of the environment to the preprocessing operation. Such influences are the traffic volume, the weather situation, street trading, engine power characteristic values, and the like, for example. The preprocessing operation can then react to this context and, for example, select which methods are applied to what degree.

In a preferred embodiment, these secured vehicle data are stored in the vehicle and later read out at the evaluation location. However, the secured vehicle data are most preferably transmitted online to the evaluation location to be able to directly analyze the test trip and the test results in an evaluation unit. Preferably, the test trip can be terminated, if there are sufficient data, or extended, if data availability is insufficient.

Preferably, the preprocessing operation is carried out by microprocessor-based hardware on which the data processing software runs—for example, a computer or a programmable logic data processing system. An implementation as an integrated circuit (IC), e.g., as an application-specific integrated circuit (ASIC) or field programmable gate array (FPGA), is also possible. Mixed forms are also possible.

The preprocessing operation uses methods such as normalizing, resolution reduction, anonymization, de-referencing, or overlaying from a method library. The methods can be applied permanently to a vehicle data record, but methods can also be applied depending on the model of the preprocessing operation. Then methods may be applied in parallel or sequentially or in combinations thereof. The application of the methods can also be dependent on correlation functions and on the context. Preferably, the methods are applied to such an extent that a predefined degree of anonymity is just met.

However, new, alternative, or additional methods can also be loaded into the preprocessing operation as needed. In a preferred embodiment, an addition of new, alternative, or additional methods can run on a subscription basis. Such forms can function, for example, on a subscription basis. This allows new methods to be added via regular software updates, or during routine examination in a workshop. This can be necessary if new developments enable access to protected data which were not possible previously.

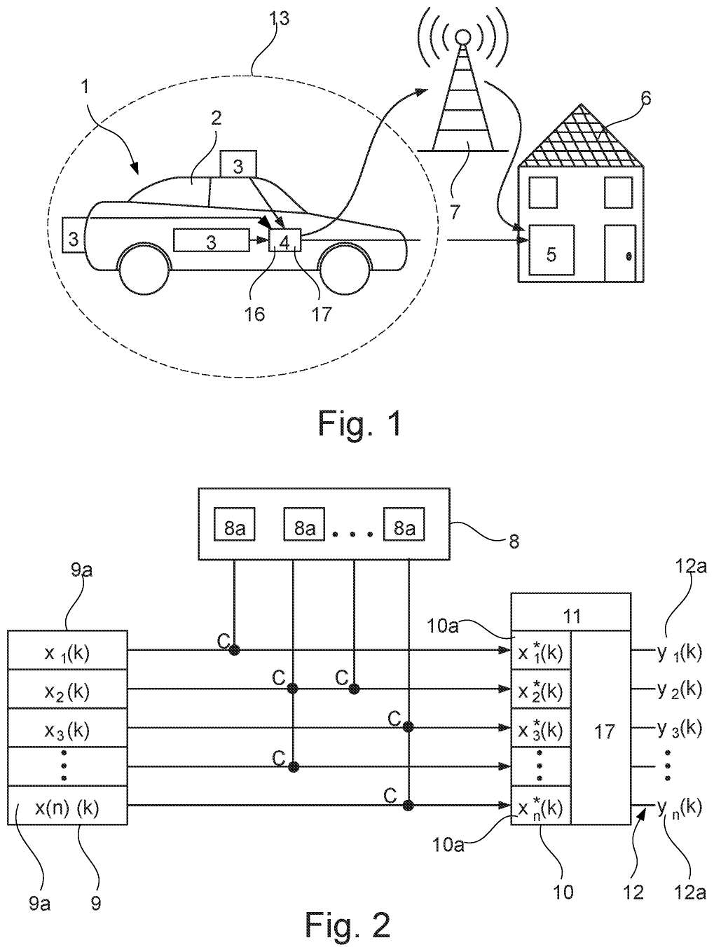

The present invention is described in greater detail below with reference to FIGS. 1 through 5, which show schematic and non-limiting advantageous embodiments of the invention by way of example. In the figures:

FIG. 1 is a schematic representation of the embodiment of a measurement campaign,

FIG. 2 shows a marking of the vehicle data by protected data and processing into secured vehicle data,

FIG. 3 shows a processing unit with preprocessing according to the invention, and

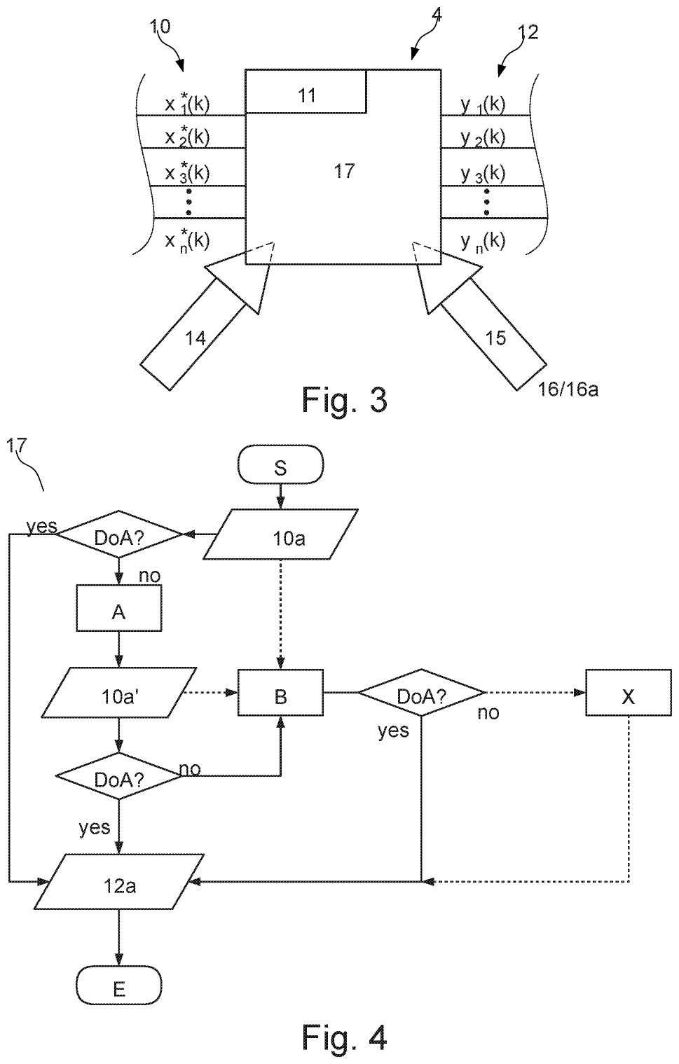

FIG. 4 shows a flowchart with the mode of operation of the preprocessing, and

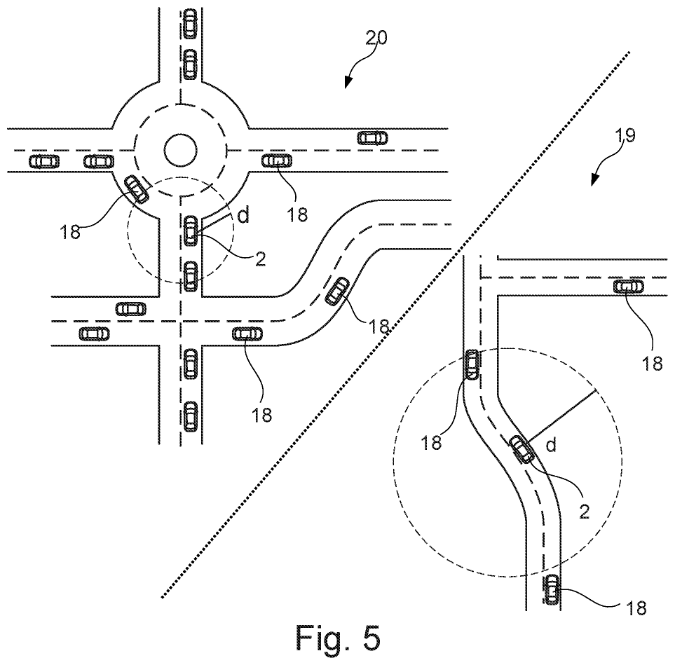

FIG. 5 shows an exemplary position processing.

FIG. 1 shows a possible arrangement 1 of a measurement campaign with a vehicle 2 according to the present invention. At least one data acquisition unit 3 and at least one processing unit 4, which are used for a measurement campaign, are located in or on the vehicle 2. A measurement campaign describes a test trip (also in the sense of several test trips, even over a longer time period) with the vehicle data 10 determined in the vehicle 2, to successfully complete this campaign.

A data acquisition unit 3 can be any measurement sensor that measures or acquires a specific variable. A data acquisition unit 3 can also acquire data from a control unit permanently installed in the vehicle. Such control units operate according to the IPO principle (input—processing—output), wherein a physical characteristic, such as speed, pressure, temperature, etc., is measured, and this value is compared with a setpoint variable entered or calculated in the control unit. If the measured value does not match the stored value, the control unit adjusts the physical process by means of actuators, so that the measured actual values again correspond to setpoint variables. The actuators thus engage correctively in a running process. Such control units in the vehicle are, for example, an engine control unit, a transmission control unit, a battery management system, or a hybrid control unit. Their input signals come from permanently installed sensors, such as speed, torque, temperature, pressure, voltage, current sensors, etc. The control units control actuators in the vehicle, such as injection pumps, inlet valves, drive batteries, drive lever actuators, etc. In a preferred embodiment, such control units are connected to one another in a system-wide manner by means of system buses.

For example, such a data acquisition unit 3 can also be a GPS position determiner, an exhaust gas measuring unit, an environment camera, a temperature sensor, an air humidity measuring unit, etc. The invention is not limited to these exemplary measurement sensors. Different data acquisition units 3, required by a person skilled in the art for the data evaluations, can be installed in different embodiments in a vehicle. The data acquisition units 3 can be installed on the vehicle 2 as standard, but can also be arranged on the vehicle 2 specifically for carrying out the measurement campaign (for example, emission measurement technology).

The at least one data acquisition unit 3 generates vehicle data 10 in the form of at least one vehicle data record 10a. A vehicle data record 10a is understood to mean the course of an acquired variable xₙ* of the data acquisition unit 3 in a predetermined interval, in particular, during the test trip or a portion of the test trip. The acquired variable xₙ* is preferably digitized for further use, such as processing or storage. The course of an acquired variable xₙ* is understood to mean a sequence of successive measurements or data packets. Vehicle data 10 are understood to mean the totality of all individual vehicle data records 10a which are recorded during the execution of the test trip of the measurement campaign. Vehicle data records 10a can be individual recorded profiles of a data acquisition unit 3, for example. However, several vehicle data records 10a can also be created by a data acquisition unit 3. These vehicle data records 10a are preferably recorded as a function of a control variable k, such as time recorded (xₙ(t)), or also as a function of the position (e.g., geographical coordinates (length, width, height) xₙ(x,y,z) or also route xₙ(s)).

Vehicle data records 10a can be data which describe the vehicle state and are acquired using known measuring sensors or control units, such as position, speed (also in space), acceleration (also in space), engine power, engine speed, engine torque, engine temperature, coolant temperature, wheel speed, tire slip, etc., but also data which describe the environment of the vehicle 2, such as by means of radar, LIDAR, a camera, an infrared sensor. Vehicle data records 10a can also be data relating to other data sources, such as road data from digital road maps (e.g., topology of the road) or weather data from digital weather services, or information that is transmitted from other vehicles via vehicle-to-vehicle communication (e.g., car-to-car communication (C2C), or a combination of vehicle-to-vehicle and vehicle-to-infrastructure communication (V2X)). Data which are manually input or triggered by the driver or a passenger during travel, such as activation/deactivation of a function in the vehicle, can also be vehicle data records 10a.

The present invention also contains at least one processing unit 4, which is also provided on or in the vehicle 2. The processing unit 4 receives the vehicle data 10 which are continuously acquired with the at least one data acquisition unit 3 during a trip with the vehicle 2. A data acquisition unit 3 can transmit the acquired vehicle data 10 directly to the processing unit 4—for example, via a suitable wiring system or wirelessly.

The processing unit 4 consists of at least one preprocessing operation 17 (FIGS. 2 and 3). The processing unit 4 can also comprise a memory unit 11 in which data can be stored. However, the memory unit 11 can also be arranged externally and connected to the processing unit 4 by a suitable data connection.

There are also protected data 8 during a test trip. Protected data 8 describe at least one protected data record 8a, which can be seen as critical and is not to be passed on, for example, personal data in the sense of GDPR. Protected data 8 is, in particular, data which should only be accessible to a specific person himself or should also remain completely anonymous. These include, for example, personal data, such as the identity of the driver or the passenger, an address of the starting point, and data of third parties who interact with the vehicle 2 during the test trip. Such critical data can be recorded during the test trip by a data acquisition unit 3 (i.e., a vehicle data record 10a), but can also be entered or specified for a test trip, for example, data regarding the driver, regarding the vehicle 2, driving route, etc.

However, protected data 8 have an influence on vehicle data 10, as illustrated and explained with reference to FIG. 2. For example, the driving style of the driver can influence the speed, acceleration, stopping, etc. A specific vehicle data record 10a for the same route can thus be different for different drivers. Traffic volume, such as traffic jams, or the position, in urban or rural areas, or other road users also influence the trip and the driving style of the driver and have an influence on the vehicle data 10. This influence of the protected data 8 upon vehicle data 10 is referred to as “marking.”

A vehicle data record 10a can therefore be influenced by a marking. In one arrangement, an unmarked vehicle data record 9a, which contains a variable xₙ, is therefore influenced by the marking and made part of the vehicle data record 10a recorded by the data acquisition unit 3. Unmarked vehicle data 9 contain at least one unmarked vehicle data record 9a. Unmarked vehicle data records 9a cannot be accessed directly, because they are only merged into vehicle data records 10a due to the marking and are acquired as vehicle data records 10a. However, it should be noted that not every acquired vehicle data record 10a must be marked by protected data 8.

This marking can take place in very different ways. On the one hand, data such as driver, passengers, position data mark the vehicle data 10, but these can also be marked by third parties (e.g., other road users) and environmental factors (rain, snowfall). For example, a temporal profile of acceleration during a trip along a certain distance depends on the vehicle type and the load capacity, on the driving behavior of the driver, on the surroundings (e.g., pedestrians), on the time of the trip, etc. On the other hand, a temporal profile of an acceleration is also dependent upon the route itself.

The influence of the marking on a vehicle data record 10a can be described, for example, by means of at least one correlation function C (FIG. 2). The correlation function C describes how protected data 8 mark the unmarked vehicle data record 9a and merge into a vehicle data record 10a. The correlation function C is dependent on the protected data 8 and, for example, a known function which describes the influence of protected data 8 on vehicle data 10. The correlation functions C for different unmarked vehicle data records 9a and/or protected data 8 are generally not the same, since various unmarked vehicle data records 9a can be marked differently by protected data 8. A correlation function C can, for example, be known from the literature, or can be determined via test series. The correlation function C can be dependent on the number of generated vehicle data records 10a. For example, with a repeated trip by an identical driver, the acceleration profile can always be similar or even the same. As a result of a larger quantity of identical vehicle data records 10a, it is therefore more likely that the driver will be identified. A correlation function C can therefore be used to describe the influence of the marking on the vehicle data 10a and possibly also to weight this.

Not every protected data record 8a has to have a correlation function C with each vehicle data record 10a. For example, the driver behavior can have an influence on acceleration and a retrieved engine power, but not on outside temperature or atmospheric humidity. The selected route can influence, for example, the environmental conditions experienced by it, such as weather, snowfall, and therefore has an influence on temperature and humidity data.

Due to this marking, the vehicle data 10 acquired with a data acquisition unit 3 enable an indirect conclusion to be drawn about the protected data 8. If, for example, an acceleration profile has been found as a function of time t as a vehicle data record 10a, a distance traveled and thus a theoretical position relative to the start can be determined by means of two-fold integration. With knowledge of the possible starting point, which may be given for obvious reasons, the route could be recalculated. From the vehicle data 10, a driver's driving style could also be deduced, which ultimately makes it possible to deduce the identity and further properties of the driver.

The preprocessing operation 17 comprised in the processing unit 4 serves to modify the vehicle data 10 before the forwarding to the evaluation unit 5, such that drawing a conclusion about the protected data 8 is unlikely, or even impossible, on the basis of the vehicle data 10. The specification of the probability of a possible conclusion is described via a degree of anonymity 14 (“Degree of Anonymity”—DoA) (FIG. 3). In a preferred embodiment, this degree of anonymity 14 can be designed as a known k-anonymity. The degree of anonymity 14 is a characteristic variable which represents the conclusion about protected data 8 and is predefined for the preprocessing operation 17 of the vehicle data 10, e.g., by a user, and is therefore known.

One possibility for quantification of the degree of anonymity 14 consists in the probability p that a certain person can be identified in the secured vehicle data 12 (via the protected data 8). The degree of anonymity is then 1-p. For example, in the case of a probability of an assignability of p=0.01 (1%), the degree of anonymity is 0.99 (99%).

A likewise possible quantification consists in the specification of the smallest possible group of N persons for which an assignment of the protected data is likely to be the same. In the example just mentioned with p=0.01, N=100. For example, with a degree of anonymity 14 of greater than 99% for the identification of the driver (with the same probability of identification of a driver), a vehicle data record 10a would have to be modified by the preprocessing operation 17 such that at least one resulting secured vehicle data record 12a is created. In the preferred use of a k-anonymity with k>99 as a degree of anonymity 14, the vehicle data record 10a is modified in such a way that a conclusion about at least 100 persons (N=100) is likely to be the same during data evaluation of the secured vehicle data record 12a.

In a further embodiment, the degree of anonymity 14 can also be bound to a cost factor which describes the required effort for determining a specific protected data record 8a from a resulting secured vehicle data record 12a. This effort can be calculated or estimated via computing power, time expenditure, and manpower for an attack. Depending upon the associated effort, the attack can be assigned a categorization (Level of Security), such as “low,” “medium,” “high.” “Low” would represent very low effort, as before, in computing power, time effort, while “high” characterizes a very high effort.

Different degrees of anonymity 14 can also be used for different unmarked vehicle data 9.

These categorizations can be made for protected data 8 by the user and, for example, depend on the type of protected data 8. Since an attack can never be completely ruled out, only a risk minimization can always be carried out on the basis of this categorization. Using the categorizations, the risk minimization can be associated with a probability that an attacker gains access to protected data 8. For example, it can be required that, for a categorization of “high,” the probability of being able to draw conclusions about a specific person on the basis of a vehicle data record 10a shall be less than 1% equiprobable. The value of the degree of anonymity 14 would then run to a probability value, as already calculated above, of greater than 99%.

The secured vehicle data record 12a then comprises a modified variable yₙ, which results from an acquired variable xₙ* by the preprocessing operation 17 and which corresponds to the specification of the degree of anonymity 14. The degree of anonymity 14 can be set by the user—for example, by the driver himself or a development engineer.

The degree of anonymity 14 should be selected such that the information content of the data is reduced as little as possible or no longer than required. If the degree of anonymity 14 is set too high by the user, the secured vehicle data 12 may be unusable even for a legitimate user. For example, in an RDE measurement trip, accurate information about the driving behavior (acceleration, driving style) is required, which would, however, be modified at a high degree of anonymity 14 so as to enable no assignment to a specific driver. Preferably, the integrity of the vehicle data 10a regarding the exhaust gas composition is more important for the legitimate user in a measurement campaign for RDE than, for example, the GPS geographical coordinates in the same measurement campaign. The degree of anonymity 14 can then be selected to be substantially higher in this measurement campaign for the vehicle data record 10a, “GPS geographical coordinates,” than for the exhaust gas composition.

The preprocessing operation 17 can use various methods 16 for data processing. For example, methods 16, such as normalization, anonymization, overlaying, reduction in the resolution, etc., which are frequently used in the preprocessing operation 17, can be carried out. Normalization is understood to mean the mapping of the absolute values of a variable xₙ* of a vehicle data record 10a to values between 0 and 1 (or −1 and +1). This can be done by dividing all values by the maximum value of the values. This is, for example, a suitable method for processing speed data or acceleration data. For example, by integrating the acceleration, it makes it difficult to deduce the route of the test trip, if the maximum value or reference value is not known.

In a preferred embodiment, a reduction in the resolution can also be applied. In an illustrative manner, locality coefficients, for example, of locations traveled through during a test trip are reduced from 5 points to 2 points. Test drivers are not stored with their names, for example, but are abstracted only as “male” or “female.” Such a masking is also used, for example, in digital road maps. The lowest-value bits of object coordinates are set to zero, for example, and a “pixelation” of the digital road map is thereby performed. If, for example, GPS data is reduced in resolution in this way, the accuracy of the acquired GPS position is reduced. Such methods are also often referred to as “microaggregation.”

In the “anonymization” method 16, person-assignable data is removed or replaced by non-assignable data. As an example, the attentiveness assistant can be mentioned, which in some vehicles is implemented with the aid of a video camera facing the driver to monitor the pupil activity of the driver. These video data are usually deleted immediately after the evaluation, but could be required for development or troubleshooting in a later analysis. In this case, these vehicle data (10a) could comprise biometric personal features (for example, eye color and iris patterns). Although these are also recorded with the camera, they are not absolutely necessary for the detection of the attentiveness by monitoring of the pupil activity. In this case, a method 16 would be to replace the actual eye color by a randomly selected one (anonymization). A further method 16 could superimpose the region of the iris in the image with image noise, and thus hinder accurate assignability or make it impossible.

The methods 16 of data processing are merely examples for illustrating the mode of operation and are not limited to those mentioned, but, rather, all methods 16 which are apparent to a person skilled in the art can be applied.

All possible forms of data processing are referred to below as methods 16. The preprocessing operation 17 uses at least one method 16, which is used in the preprocessing operation 17, and is selected depending upon the vehicle data record 10a. However, it is of course possible that several methods 16 also be applied to a vehicle data record 10a. The selection of the suitable or required methods 16 can be specified, for example, by the user for a measurement campaign in question, or can be automated by the preprocessing operation 17. A method 16 preferably modifies a vehicle data record 10a into at least one secured vehicle data record 12a. Most preferably, the vehicle data record 10a is analyzed by preprocessing operation 17 and is only modified, if a conclusion is drawn about protected data 8.

In a preferred embodiment, a method 16 can process a vehicle data record 10a independently of a control variable k, such as time or geographical coordinates. For example, the same method 16 is applied permanently to a vehicle data record 10a and generates a secured vehicle data record 12a. In this case, the method 16 can remain unmodified and can always be applied to a vehicle data record 10a in the same way.

In a preferred embodiment, the preprocessing operation 17 includes a process as shown in FIG. 4. A preprocessing operation 17 is preferably a software-implemented solution which functions, for example, according to the flow diagram in FIG. 4. After starting the routine S, a vehicle data record 10a is analyzed by the preprocessing operation 17. If the vehicle data record 10a corresponds to the predetermined degree of anonymity 14 (yes), it is stored as a secured vehicle data record 12a, for example, in the storage unit 11, and the preprocessing operation 17 is terminated (working step E). A secured vehicle data record 12 can then be transmitted to an evaluation unit 5 for further processing. If the vehicle data record 10a does not correspond to the degree of anonymity 14 (no), it is modified via a first method 16 (working step A). A modified vehicle data record 10a′ is thereby created. If the modified vehicle data record 10a′ corresponds to the degree of anonymity 14, it is stored as a secured vehicle data record 12a, and the preprocessing operation 17 is terminated (working step E). If it does not correspond, the preprocessing operation 17 can choose, whether it selects the original vehicle data record 10a or the modified vehicle data record 10a′ as input for a second method 16 (working step B). This can be specified depending upon the applied methods 16 and/or can be specified by the user. If, after application of the second method 16, the degree of anonymity 14 is met (yes), the modified vehicle data record 10a′ is again stored as a secured vehicle data record 12a. This loop can be repeated, using different methods 16, until the degree of anonymity 14 is met. FIG. 4 denotes this loop by working step X.

Alternatively, a vehicle data record 10a could also be discarded, when the degree of anonymity 14 cannot be met after a predetermined number of methods 16. In this case, the methods 16 to be applied and also their order can be defined in advance (for example, by configuration by a user) or can be specified. Preferably, the aforementioned sequence for a vehicle data record 10a is repeated at regular intervals depending upon the control variable k—for example, as a function of time. For example, analogously to the above description, only parts of a vehicle data record 10a dependent upon the control variable k can also be stored, and others can be discarded, when the degree of anonymity 14 is not met.

For example, correlation functions C can also be incorporated into the preprocessing operation 17, or also the context 13 (FIG. 1). The context 13 describes the surroundings of the vehicle 2, which can be recorded via various data acquisition units 3. In a preferred embodiment, correlation functions C and context 13 can influence the selection of the methods 16; in a highly preferred embodiment, correlation functions C and context 13 can also influence the effect of a single method 16. For example, this method 16 can be applied to a vehicle data record 10a to varying degrees, and can effect, for example, a different reduction in the resolution in a vehicle data record 10a.

For example, the preprocessing operation 17 can function in a way that, with a low traffic volume, measured by the context 13, a method 16 is applied on the basis of GPS geographical coordinates, which method performs a high reduction in the resolution of the position of the vehicle 2 to meet a degree of anonymity 14. In the case of a high traffic volume, the preprocessing operation 17 with the method 16 can carry out only a slight reduction in the resolution, or continue even with the original vehicle data record 10a and immediately generate a secured vehicle data record 12a which meets the specified degree of anonymity 14. The context 13 could, for example, control the application of the method 16 (high reduction, low reduction, no reduction at all) in the above example by transmitting the GPS geographical coordinates, and thus can be integrated into the preprocessing operation 17.

In a further preferred embodiment method, correlation functions C and context 13 can also have an influence on the degree of anonymity 14 and thus can indirectly influence the application of methods 16 in the preprocessing operation 17.

The sum of all methods 16, which are used in the preprocessing operation 17, is called the method library 15. In a preferred embodiment, according to the specification of the user, the methods 16 from the method library 15 are selected individually for each vehicle data record 10a. In a highly preferred embodiment, the preprocessing operation 17 can independently select the methods 16 from the method library 15 to obtain a secured vehicle data record 12a. The methods 16 can be applied sequentially, as provided in FIG. 4, but a parallel application of methods 16 would also be possible. A method library 15 can comprise a number of prestored methods 16 which have been described above. New methods 16 can also be fed into the method library 15 by the user to ensure the security of the protected data 8. The protected data 8 can, for example, be detected by new types of attacks and can be determined by analysis methods from the secured vehicle data 12, or new measuring methods in the vehicle 2 require new methods 16a to ensure the security of the protected data 8. In a preferred embodiment, the method library 15 is updated on a subscription basis at regular time intervals, and new methods 16a are fed in. New methods 16a may, for example, only be in development and may be based on methods 16, or may follow a completely different approach. New methods 16a can preferably be developed via “big data” analysis of performed test trips of the vehicle 2. Such an update can take place promptly via wireless transmission protocols such as short-range communications protocols such as Bluetooth, or via long-range communications protocols such as 4G and 5G. In a preferred embodiment, however, an update can also be installed via a vehicle bus or short-range communications protocols such as Bluetooth during a planned garage visit by the vehicle 2.

The preprocessing operation 17 generates secured vehicle data 12 with at least one secured vehicle data record 12a (y₁(t) to yₙ(t)) by means of methods 16. These secured vehicle data 12 are stored in the vehicle 2 or sent only after preprocessing operation 17. Vehicle data 10 are therefore not stored. It is thus not possible to access vehicle data 10 and protected data 8.

The secured vehicle data 12 can be read out subsequently at the location of a data evaluation 6. This readout can preferably take place in a wired manner via a plug connection for data transfer, but it can also be done wirelessly, e.g., via WLAN or Bluetooth. The secured vehicle data 12 can be added to an evaluation unit 5. However, the secured vehicle data 12 can also be transmitted during the test trip via a transmission unit by means of a transmission protocol such as 5G (as indicated in FIG. 1 with the transmitting mast 7) and can then be supplied directly (online) to an evaluation unit 5 at the evaluation location 6. Preferably, the secured vehicle data 12 can also be read out in the vehicle 2 after processing.

In an exemplary embodiment in FIG. 5, the mode of operation of the preprocessing operation 17 in the processing unit 4 is described demonstratively, but not conclusively. A vehicle 2 makes a test trip in a rural area 19 with few other road users 18; in addition to other vehicle data 10a, the vehicle position is also acquired cyclically via GPS, e.g., at 10 Hz, and is recorded as a vehicle data record 10a.

Vehicle data 10 are marked by driver and road network and other road users 18, e.g., by the driving style of the driver, which marks the temporal profile of the position data. The vehicle speed can be determined from a time series of the vehicle position data, after a first derivative according to time, and, for example, the compliance with valid traffic rules can be checked. Repeated derivation allows the vehicle acceleration to be obtained, which can serve to estimate the driving style (e.g., braking before intersections or curves, etc.).

At the same time, during the trip, the position data of the vehicle 2 are identical to the position data of the driver. Thus, the driver of the vehicle 2 can be identified by comparing a time series of the vehicle position data with a third data source, and thus the determined vehicle data 10 of driving behavior can be assigned as personal data. For example, individual position measurements of the driver's smartphone, which are present at the operator of the radio network, or position data acquired by various applications on the smartphone can be used as such a third data source. If one or more measurements of (position, time) from the smartphone can be found by checking a match of location and time with measurement points in the time series of the vehicle data 10a of the vehicle 2, a dependence can be concluded. The high-resolution time series of the position data of the vehicle can thus be assigned to a person, just like the findings derived therefrom (driving style, consideration of the traffic rules, behavior with respect to other road users, etc.).

In order to meet the degree of anonymity 14 and to make conclusions about protected data 8 impossible—here, for example, (a) the driving style and (b) the exact location of the driver—one of the following methods 16 can be applied in the preprocessing operation 17:

a. Reduction in Resolution

This can relate to either the temporal resolution or the spatial resolution, or both. This results in a region (temporally and spatially) within which an unambiguous assignability is no longer possible. Depending upon the number of smartphones with available position data in this region, an ambiguity in an assignment and thus a desired degree of anonymity 14 (e.g., k-anonymity) arises.

In this case, a second effect also results: Depending upon the road density at the position, a unique assignment to a specific roadway is thus more difficult, and the speed or acceleration calculated by time derivative is also less precise. The determination of the driving style can thus be made more difficult or impossible.

b. Normalization

The position data can also be recorded as a relative position in relation to a (unknown) starting point. Although speed and acceleration can thus be calculated precisely, an assignment to a specific traffic area and determination of the driving behavior is difficult to impossible. In addition, a comparison with a third data source as described above is also more difficult.

The effectiveness of variant a) is thus dependent upon the current position or the given prevailing density on roads and other road users (context 13), and available position data of smartphones. If few road users 18 are in the vicinity, the resolution is greatly reduced. The diameter d is thus selected to be large, which corresponds to a test trip in the rural region 19. The vehicle data record 12a secured by the preprocessing operation 17 now makes it impossible for conclusions to be drawn about either the driver or the vehicle. By contrast, during a test trip of a vehicle 2 in an urban region 20, the method of resolution reduction may be used only to a limited extent. The radius d is selected to be small, since many other road users 18 are in the vicinity, and therefore the assigned degree of anonymity 14 can be met with a small amount of blurring in the position determination.

1. A method for data acquisition in a vehicle, comprising:
at least one data acquisition unit and at least one processing unit, wherein the at least one data acquisition unit records at least one vehicle data record that is marked by at least one protected data record, wherein a preprocessing operation of the at least one vehicle data record is carried out in the at least one processing unit, wherein the preprocessing operation comprises the following steps, taking into account a predetermined degree of anonymity:
loading the at least one vehicle data record into the preprocessing operation,
applying at least one method to the at least one vehicle data record to modify the at least one vehicle data record,
analyzing whether the degree of anonymity is met by the modified vehicle data record,
storing the at least one modified vehicle data record which meets the degree of anonymity as an at least one secured vehicle data record to prevent indirect conclusion from the secured vehicle data record on the at least one protected data record.

2. The method according to claim 1, wherein the preprocessing operation can access at least one method from a method library.

3. The method according to claim 1, wherein the preprocessing operation applies at least one method permanently to the vehicle data record and in doing so creates the at least one secured vehicle data record.

4. The method according to claim 1, wherein the preprocessing operation, depending upon at least one control variable, applies at least one method to the at least one vehicle data record and in doing so creates the at least one secured vehicle data record.

5. The method according to claim 1, wherein the preprocessing operation depends upon at least one correlation function and upon a context.

6. The method according to claim 1, wherein the preprocessing operation applies at least two methods sequentially or in parallel.

7. The method according to claim 1, wherein the method library functions on a subscription basis, and new methods are added to the method library.

8. The method according to claim 1, wherein the degree of anonymity is bound to a cost factor and receives a categorization.

9. A device for data acquisition in a vehicle, comprising:
at least one data acquisition unit and at least one processing unit, wherein the at least one data acquisition unit records at least one vehicle data record that is marked by at least one protected data record, wherein a preprocessing operation is provided in the at least one processing unit, wherein the preprocessing operation, taking into account a degree of anonymity, modifies the at least one vehicle data record, by using at least one method to convert the at least one vehicle data record into a modified vehicle data record, and wherein a memory unit is provided which stores the modified vehicle data record, which meets the degree of anonymity, as a secured vehicle data record, so that an indirect conclusion about at least one protected data record from the secured vehicle data record is prevented.
